(19) United States
(12) Patent Application Publication
(10) Pub. No.: US 2016/0146255 A1
(43) Pub. Date: May 26, 2016

(54) SEAL ASSEMBLY FOR BEARING APPLICATIONS

(71) Applicant: Rico Dittmar, Schweinfurt (DE)

(72) Inventor: Rico Dittmar, Schweinfurt (DE)

(73) Assignee: Aktiebolaget SKF, Goteborg (SE)

(21) Appl. No.: 14/949,373

(22) Filed: Nov. 23, 2015

(30) Foreign Application Priority Data
Nov. 21, 2014 (DE) 10 2014 223 828.5

(51) Int. Cl. F16C 33/78

(52) U.S. Cl. CPC F16C 33/7869

(57) ABSTRACT

A seal assembly includes a race and a seal ring, and the race includes an axially extending race section and at least one radially extending race section that meet at a transition region. The radially extending race section is disposed at a first axial end of the axially extending race section, the seal ring includes at least one first seal lip configured to abut on the axially extended race section, and the transition region includes at least one through opening or at least one gap.

### CROSS-REFERENCE

This application claims priority to German patent application no. 10 2014 223 828.5 filed on Nov. 21, 2014, the contents of which are fully incorporated herein by reference.

### TECHNOLOGICAL FIELD

The present disclosure is directed to a seal assembly that includes a race and a seal that slidingly engages the race.

### BACKGROUND

Various conventional seal assemblies are known that may be used in rolling-element bearings or radial shaft bearings. These conventional seals may include a seal ring and a race. In such assemblies, the seal ring rests with at least one seal lip on (in contact with) the race. In addition, races sometimes include a radially oriented seal surface, and a second seal lip of the seal ring may contact the radially oriented seal surface to form a gap seal.

For example, DE 102009005775 discloses a bearing seal assembly that includes a seal ring and a race. The seal ring is attached to a bearing outer ring, the race is attached to a bearing inner ring, and the seal ring contacts the race on an axial race surface. In addition to the axial seal surface, the race may include a radially extending projection or “flinger” at an interior end of the axial seal surface and another radially extending flinger at an exterior end of the axial seal surface, both flingers extending in the direction of the bearing outer ring. The flinger toward the bearing interior includes a radial seal surface that is also contacted by the seal ring. The flingers help guide or transport lubricant radially outwardly under the influence of centrifugal force when the bearing rotates.

Disadvantageously, in such seal assemblies, lubricant present on the bearing exterior or even contaminants from the bearing exterior, may be captured by the flinger and may accumulate between the flinger and the seal ring. This is especially problematic when the bearing is not moving. These contaminants may reach the bearing interior through the bearing seal assembly. However, especially with bearing seal assemblies used in engine applications, it is important to prevent lubricants or contaminants from the bearing exterior from penetrating into the bearing interior, and conversely to prevent liquefied grease from the bearing interior from escaping to the bearing exterior.

### SUMMARY

A first aspect of the present disclosure is to provide a seal assembly having very good sealing properties even when movable bearing parts are not moving.

According to the disclosure a seal assembly includes a race and a seal ring. The race includes an axially extending race section and at least one radially extending race section, and at least one first seal lip of the seal ring abuts on the axially extending race section. The at least one radially extending race section is preferably disposed on the race at a bearing exterior and functions as a flinger that can transport lubricant on the bearing exterior radially outward when the bearing rotates. This helps protect the seal assembly against contaminants carried in from outside.

In order to prevent lubricant and contaminants from accumulating, the disclosure assembly includes at least one opening or gap at a transition region between the axial race section and the radial race section. This opening or gap allows oils or lubricants to flow away from the seal lips and the race, in particular when the movable bearing parts are not moving. At the same time the advantageous “flinging” effect of known flingers can be retained. The opening or gap can be, for example, punched or stamped in the race using techniques known from the prior art, by using a press, for example.

In one advantageous exemplary embodiment the radial race section extends towards the seal ring. During rotation of the bearing centrifugal force can thereby arise in a targeted manner. Lubricant and contaminants can be led away or flung outwardly and thus prevented from penetrating into the bearing interior.

An axially outer side of the radial race section on the bearing exterior side may advantageously lie in a plane that is coplanar with (approximately axially flush with) an axially outer surface of the seal ring, and this may reduce required installation space. Alternatively, the radial race section can protrude beyond the seal ring in the axial direction, and this may allow the lubricant to be better transported to the bearing exterior. In either manner, lubricant can be prevented from penetrating to the bearing interior.

According to a further exemplary embodiment, the radial race section includes an edge facing away from the axial race section. This edge may be referred to in the following description as the outer edge. The opening preferably extends out over the outer edge. Advantageously at least two openings are formed in the radial race section and define a radially extending lug between them. When the bearing rotates, the lug can function as a flinger as described above. At the same time, in the event of bearing stoppage accumulated oil can flow away via the opening that is formed between the at least two lugs. Stated differently, the exterior portion of the axial race section may include a plurality of lugs separated by gaps rather than “openings” per se. It is these gaps that may sometimes be referred to as openings that extend out over the outer edge.

According to a further advantageous exemplary embodiment a second radially extending race section is disposed in the bearing interior. This second race section can also function as a flinger. Thus, grease in the bearing interior, which due to the high temperatures in the bearing interior is present in liquefied form, can be transported back to the bearing interior. The second radial race section preferably also extends towards the seal ring.

In this embodiment as well, at least one opening can also be formed at a second transition region between the axial race section and the second radial race section, via which the low-viscosity grease can flow away during bearing stoppage and be available again to the bearing assembly. That is, the second radial race section may include openings and/or lugs at the junction of the axial and radial race sections in the same manner as the first radial race section described above.

The race itself is preferably manufactured one-part, which may reduce manufacturing time and manufacturing costs. However, it is also possible to manufacture the two radial race sections separately from the axial race section, and this may allow for greater design flexibility.

In a further preferred exemplary embodiment the second radial race section on the bearing interior is thinner than the first radial race section on the bearing exterior, and this may help minimize installation space and reduce material costs and reduce the weight of the race. Such a thinner construction may also help drops of low-viscosity grease to break free from the outer edge and move radially outwardly. Meanwhile, the greater material thickness of the radial race section facing the bearing outside remains able to withstand the higher loads expected to occur there.

The second radial race section may advantageously further include a radially oriented seal surface that is configured to form a gap-type seal with a further seal lip of the seal ring. Due to the one-piece design of the seal surface with the second radial race section, separate structures and the costs associated therewith can be avoided.

Another aspect of the disclosure relates to a bearing that has a bearing outer ring and a bearing inner ring, and a seal assembly of the above-described type disposed therebetween.

The disclosure is explained in more detail below with reference to the exemplary embodiments depicted in the drawings, which exemplary embodiments are of a purely exemplary nature and are not intended to establish the scope of the application. This scope is defined solely by the patent claims.

### BRIEF DESCRIPTION OF THE DRAWINGS

FIG. 1 is a perspective view, partially in section, of a seal assembly according to an embodiment of the present disclosure.

FIG. 2 is a perspective view, partially in section, of a further embodiment of a seal assembly according to the present disclosure.

### DETAILED DESCRIPTION

In the following discussion, identical or functionally equivalent elements are designated by the same reference numerals.

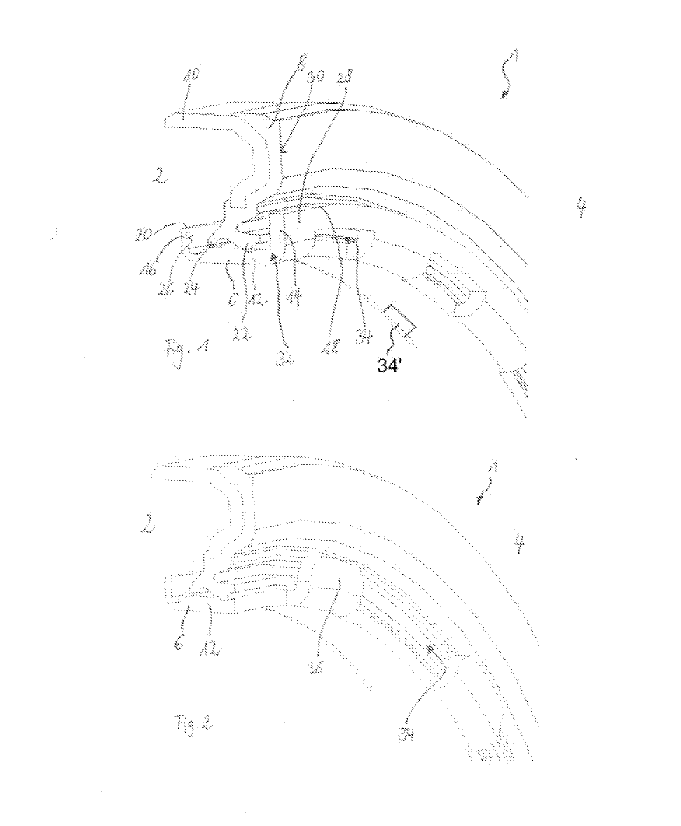

FIG. 1 shows a seal assembly 1 according to the present disclosure that is usable for sealing a grease-lubricated rolling-element bearing or sliding bearing which bearing includes a bearing inner ring (not shown) that is rotatable relative to a bearing outer ring. The seal assembly 1 may be used in a motor vehicle engine and is configured to protect a bearing interior 2 from the penetration of oil or lubricant from a bearing exterior 4. The seal is also configured to prevent high-temperature-resistant grease from the bearing interior 2 from escaping to the bearing exterior.

In order to provide this seal function, the seal assembly 1 includes a race 6 disposed on the bearing inner ring (not shown) and a seal ring 8 connectable to the bearing outer ring (not shown). The seal ring 8 is in turn connected to a metallic reinforcing body 10 disposed on the bearing outer ring.

With continued reference to FIG. 1, the race 6 includes an axially extending race section 12, a first race section 14 extending radially towards the seal ring 8, and a second race section 16 extending radially towards the seal ring 8, which are each disposed on the bearing exterior 4 or on the bearing interior 2. These radial race sections 14, 16 each include an outer edge 18, 20 facing away from (radially spaced from) the axial race section 12.

When a bearing equipped with such a seal assembly rotates, during operation of an engine, for example, the two radial race sections 14, 16 of the race 6 function as flingers. Lubricants, driven by centrifugal force caused by the rotation of the bearing, are transported radially outward from the axial race section 12 up to the flingers 14, 16, and from there flung back over the outer edge 18, 20 to the bearing exterior 4 or bearing interior 2. The race section 16 is configured to transport high-temperature grease to the bearing interior 2, and the race section 14 is configured to transport oil, lubricants, or contaminants to the bearing exterior 4. In this way, oil is prevented from penetrating from the bearing exterior 4 to the bearing interior 2, and liquefied grease is prevented from escaping from the bearing interior 2 to the bearing exterior 4. As shown in FIG. 1, the radial race section 16 of the bearing interior 2 can be thinner (in an axial direction) than the radial race section 14 of the bearing exterior 4, and this may reduce installation space and costs.

As can further be seen from FIG. 1, the seal ring 8 includes a first seal lip 22 configured to abut on the axially oriented race section 12. The seal ring 8 further includes a second seal lip 24 that forms a gap seal with a seal surface 26 of the race 6. Here the seal surface 26 is configured one-piece with the radial race section 16, and thus costs for separate structures can be avoided.

Furthermore, it can be seen in FIG. 1 that the seal ring 8 is configured such that the radial race section 14 disposed in the bearing exterior 4 terminates with its axial end side approximately flush with an axial end side 30 of the seal ring 8. However, it is also possible to design the race 6 such that the end side 28 of the external radial bearing section 14 axially protrudes beyond the seal ring 8. In other words, the axially outer side of the radial race section 14 lies substantially in the same plane as the axially outer side of the seal ring 8, but it may also protrude beyond the seal ring 8.

Since the bearing must always be protected against dirt penetration, but it is not always critical to prevent an escape of lubricant from the bearing interior, the internal radial race section 16 may be omitted under some conditions.

FIG. 1 also shows openings 34, formed, for example, by punching, in a transition region 32 between the axial race section 12 and the radial race section 14 of the bearing exterior. These openings 34 allow oil or lubricant that accumulates in the transition region 32, such as when the bearing is not rotating, to flow away from the seal assembly 1. This may help prevent lubricant and contaminants from reaching the bearing interior 2. In the absence of the openings 34, the lubricant accumulating in the transition region 32 may increase a pressure on the seal lip 22 and briefly lift the seal lip 22 from the axial race section 12, thus allowing lubricant and/or contaminants into the bearing interior 2. The openings 34 prevent this pressure buildup from occurring and allow the lubricant to be guided back to the bearing exterior 4. Thus a penetrating of lubricants and contaminants into the bearing interior 2 can be prevented. In other words, the radial race section 14 includes a circumferentially continuous portion and openings 34 are located at the transition region.

Additionally or alternatively the radially extending race section 16 of the bearing interior 2 can include at least one opening 34′. During bearing stoppage grease can thereby flow back towards the bearing interior 2.

FIG. 2 shows a further exemplary embodiment in which the openings 34 extend over the outer edge 18, so that lugs 36 are formed. That is, the “openings” in this embodiment may be described as “gaps” between adjacent pairs of lugs. The lugs 36 are configured as radial race sections 14 and extend from the axial race section 12 radially towards the bearing outer ring. During bearing rotation the lugs 36 function as flingers and transport lubricants or contaminants back to the bearing exterior 4. In contrast, during stoppage lubricants and contaminants can flow away via the openings or gaps 34 as described above. In the manufacturing of this design, the race 6 can be formed first and the lugs 36 subsequently provided.

The seal assemblies of FIGS. 1 and 2 can be manufactured as a compact, preinstalled cassette seal unit that can be installed after bearing installation; for example, after inserting a rolling-element cage between the bearing inner ring and the bearing outer ring. If a rolling-element cage is provided, it preferably axially covers the radial race section 14 disposed on the bearing interior 2, so that grease flung forward radially from the race section 14 is flung directly to the rolling-element cage or to the rolling elements held by the rolling-element cage. The grease can thereby be guided directly onto the rolling elements held by the rolling-element cage.

The disclosed seal assembly can be configured as a rolling-element bearing seal assembly or as a radial-shaft seal assembly. Due to the large temperature fluctuations that occur in engine applications, the advantages of the disclosure are particularly useful. Such seals need to prevent lubricants and contaminants from penetrating into the bearing interior, and prevent the escape of high-temperature-resistant greases from the interior. At the same time, the disclosed seal assembly allows oil collected in a transition region between the axial and the radial race section to flow away, and an accumulation of oil can be prevented.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved seal assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Seal assembly
2 Bearing interior
4 Bearing exterior
6 Race
8 Seal ring
10 Reinforcing body
12 Axial race section
14, 16 Radial race section
18, 20 Outer edge
22, 24 Seal lip
26 Seal surface
28, 30 Edge side
32 Transition region
34 Opening
36 Lug

1. A seal assembly including a race and a seal ring,
wherein the race includes an axial race section and at least one radial race section that meets the axial race section at a transition region,
wherein the radial race section is disposed at a first axial end of the axial race section,
wherein the seal ring includes at least one first seal lip configured to abut on the axial race section, and
wherein the transition region includes at least one through opening or at least one gap.

2. The seal assembly according to claim 1, wherein the at least one radial race section extends towards the seal ring.

3. The seal assembly according to claim 1, wherein the at least one through opening or at least one gap comprises at least one gap.

4. The seal assembly according to claim 3, wherein the at least one gap comprises at least two gaps that define a radially extending lug therebetween.

5. The seal assembly according to claim 1, wherein an axially outer side of the at least one radial race section is substantially coplanar with an axially outer side of the seal ring.

6. The seal assembly according to claim 1, wherein an axially outer side of the at least one radial race section protrudes axially beyond an axially outer side of the seal ring.

7. The seal assembly according to claim 1, wherein a second axial end of the axial race section includes a second radial race section that meets the axial race section at a second transition region.

8. The seal assembly according to claim 7, wherein the second transition region includes at least one through opening or at least one gap.

9. A bearing including a bearing outer ring and a bearing inner ring, and a seal assembly according to claim 1 disposed between the bearing outer ring and the bearing inner ring.

10. The seal assembly according to claim 1,
wherein the at least one radial race section extends towards the seal ring,
wherein the at least one through opening or at least one gap comprises at least two gaps defining a lug therebetween,
wherein an axially outer side of the at least one radial race section is substantially coplanar with an axially outer side of the seal ring,
wherein a second axial end of the axial race section includes a second radial race section, and
wherein a second axial end of the axial race section includes a second radial race section that meets the axial race section at a second transition region.

11. A seal assembly comprising:
a race having an axial race section and a first radial race section that extends from a first axial end of the axial race section,
wherein the first radial race section comprises either a circumferentially continuous portion or comprises a plurality of discrete lugs separated by gaps, and
wherein, if the first radial race section comprises a circumferentially continuous portion, the first radial race section meets the axial race section at a transition region, and the transition region includes at least one through opening,
the seal assembly further comprising a seal ring having at least one first seal lip configured to abut on the axial race section.

12. The seal assembly according to claim 11, wherein an axially outer side of the first radial race section is substantially coplanar with an axially outer side of the seal ring.

13. The seal assembly according to claim 11, wherein an axially outer side of the first radial race section protrudes axially beyond an axially outer side of the seal ring.

14. The seal assembly according to claim 11, wherein a second axial end of the axial race section includes a second radial race section,
wherein the second radial race section comprises either a circumferentially continuous portion or comprises a plurality of discrete lugs separated by gaps, and
wherein, if the second radial race section comprises a circumferentially continuous portion, the second radial race section meets the axial race section at a second transition region, and the second transition region includes at least one through opening.

15. A bearing including a bearing outer ring and a bearing inner ring, and a seal assembly according to claim 11 disposed between the bearing outer ring and the bearing inner ring.
